(19) United States
(12) Patent Application Publication
(10) Pub. No.: US 2009/0165619 A1
(43) Pub. Date: Jul. 2, 2009

(54) APPARATUS FOR, AND METHODS OF, DISPOSING OF TYRES

(75) Inventors: D'Arcy Shane Lacey, Timaru (NZ); D'Arcy Michael Lacey, Timaru (NZ)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(73) Assignee: ENTIRE SOLUTIONS LTD, Timaru (NZ)

(21) Appl. No.: 12/279,340

(22) PCT Filed: Feb. 23, 2007
(86) PCT No.: PCT/NZ2007/000035

§ 371 Date: Dec. 30, 2008

(30) Foreign Application Priority Data
Feb. 27, 2006 (NZ) 545585
Feb. 27, 2006 (NZ) 545587
Oct. 24, 2006 (NZ) 550743
Nov. 13, 2006 (NZ) 551261

(51) Int. Cl. B26D 1/00; B26D 3/00; B60C 25/00

(52) U.S. Cl. 83/184; 83/187; 83/701; 157/1.1; 83/452

(57) ABSTRACT

A tyre cutting apparatus includes a body member defining a mounting formation for mounting to a support structure. A cutting assembly is supported by the body member. The cutting assembly comprises a control member and a cutting unit, for cutting the tyre. The control member effects positional variation of the cutting unit relative to the body member.

### CROSS-REFERENCE TO RELATED APPLICATIONS

The present application claims priority from New Zealand Provisional Patent Application No 545585 filed on 27 Feb. 2006, New Zealand Provisional Patent Application No 545587 filed on 27 Feb. 2006, New Zealand Provisional Patent Application No 550743 filed on 24 Oct. 2006 and New Zealand Provisional Patent Application No 551261 filed on 13 Nov. 2006, the contents of all of which are incorporated herein by reference.

### FIELD OF THE INVENTION

This invention relates generally to the disposal of tyres and, more particularly, to apparatus for, and methods of, disposing of tyres.

### BACKGROUND TO THE INVENTION

Tyres which have reached the end of their useable life or reject tyres need to be disposed of. A major problem with tyres is that they take up large amounts of space and are not biodegradable. This makes them difficult to store, transport and be disposed of.

It is becoming increasingly common for local authorities to impose conditions on how and where tyres are disposed of. Some councils have imposed restrictions on the dumping of tyres in landfill sites.

Where tyres need to be cut up, due to the bulky shape of the tyres, transportation costs are prohibitive which reduces the commercial benefits which could be obtained by organisations processing the tyres by cutting them up.

Tyre changing facilities, in general, do not have the equipment to process the tyres to enable them to be disposed of. However, these tyre changing facilities make extensive use of tyre changing machines. These tyre changing machines are expensive and stand idle when not being used to replace tyres on wheel rims. Alternatively, there would be a commercial benefit in having tyre disposing machines at tyre changing facilities so that the tyre changing machines and tyre disposing machines can be used in tandem by improving efficiencies at a tyre changing facility.

### SUMMARY OF THE INVENTION

According to a first aspect of the invention, there is provided a tyre cutting apparatus which includes

a body member defining a mounting formation for mounting to a support structure; and

a cutting assembly supported by the body member, the cutting assembly comprising a control member and a cutting unit for cutting the tyre, the control member effecting positional variation of the cutting unit relative to the body member.

The body member may comprise a bracket which receives the cutting assembly. The bracket may be adjustably arranged relative to the mounting formation of the body member.

The cutting assembly may comprise a shaft received by the bracket, the shaft being axially and rotatably displaceably arranged relative to the bracket. The control member may be arranged proximate a first end of the shaft and the cutting unit may be arranged proximate a second end of the shaft. Preferably, the second end of the shaft provides a datum point for positioning the cutting unit in a desired position relative to the tyre to be cut.

The cutting unit may comprise a blade carrier and at least one blade carried by the carrier, the blade lying in a plane transverse to a longitudinal axis of the shaft.

The control member may comprise a control handle extending transversely to the shaft.

The apparatus may include a holder for holding a tyre to be cut. The holder may comprise a support member and a restraining arrangement arranged on the support member. The support member may comprise a substantially planar structure for supporting the tyre in a substantially horizontal orientation.

The holder and cutting unit may be rotatable relative to each other to effect cutting and removal of at least one side wall of the tyre.

According to a second aspect of the invention, there is provided an accessory for a tyre cutting apparatus, the accessory comprising

a holder for supporting the tyre to be cut by the apparatus; and

a restraining arrangement arranged on the holder for restraining the tyre against rotation relative to the holder.

The holder may comprise a substantially planar structure for supporting the tyre in a substantially horizontal orientation.

The holder and a cutting unit of the apparatus may be rotatable relative to each other to effect cutting and removal of at least one side wall of the tyre.

According to a third aspect of the invention, there is provided a tyre disposing machine which includes a tyre cutting apparatus as described above. The machine may further include an accessory as described above.

According to a fourth aspect of the invention, there is provided a tyre changing machine which includes a tyre cutting apparatus as described above.

The body member may be mounted on a tool arm of the machine. Preferably, the body member is removably mounted on the tool arm.

In one embodiment, the body member may define a receiving socket in which an end of the tool arm is received. In another embodiment, the body member may include a clamping arrangement for clamping about the tool arm.

The tyre changing machine may also include the accessory as described above. The accessory may be mounted, preferably removably, on a turntable of the machine.

According to a fifth aspect of the invention, there is provided a method of disposing of a tyre, the method including

mounting the tyre in a substantially horizontal orientation;

positioning a cutting unit having a cutting tool in juxtaposition to the tyre;

urging the cutting tool into at least one side wall of the tyre in a region near a tread part of the tyre; and

by relative rotation between the tyre and the cutting tool causing separation of the at least one side wall from the tread part of the tyre.

The method may include positioning at least the cutting tool of the cutting unit within a cavity of the tyre and cutting the tyre from the inside of the tyre.

Further, the method may include mounting the tyre on a support member and restraining the tyre against rotation relative to the support member. The method may include rotating the support member relative to the cutting unit.

According to a sixth aspect of the invention, there is provided a method of operating a tyre changing machine when the tyre changing machine is not being used to replace a tyre on a wheel rim, the method including

attaching a cutting tool to the tyre changing machine;

placing a tyre to be disposed of on a turntable of the tyre changing machine; and

using the cutting tool to remove side walls of the tyre to leave a tread part of the tyre.

The method may include positioning the cutting tool within a cavity of the tyre and cutting the tyre from the inside of the tyre.

Further, the method may include mounting the tyre on a support member and restraining the tyre against rotation relative to the support member. The method may include rotating the support member relative to the cutting unit.

According to a seventh aspect of the invention, there is provided a method of operating a tyre changing machine when the tyre changing machine is not being used to replace a tyre on a wheel rim, the method including

attaching a cutting tool to the tyre changing machine;

placing a tyre to be disposed of on a turntable of the tyre changing machine;

using the cutting tool to remove side walls of the tyre to leave a tread part of the tyre; and

compacting the tread part of the tyre into a form in which it occupies a reduced volume.

The method may include, prior to placing the tyre to be disposed of on the turntable, placing a holder on the turntable of the tyre changing machine to hold the tyre against rotation relative to the turntable.

The method may include compacting the tread part of the tyre by coiling the tread part of the tyre about a spindle arrangement.

The method may include, after removal of the side walls of the tyre, mounting a carrier on the turntable of the tyre changing machine, the carrier carrying the spindle arrangement.

Further, the method may include, after compacting the tread part of the tyre, retaining the tread part in its compacted form. Preferably, the method includes retaining the tread part in its compacted form by means of a retaining element.

According to an eighth aspect of the invention, there is provided a method of disposing of a tyre which includes

separating the tyre into parts having different constituent materials;

compacting at least one of the parts to occupy a reduced volume; and

disposing of the parts separately.

The method may include separating a part of the tyre containing steel from other parts of the tyre not containing steel.

According to a ninth aspect of the invention, there is provided a method of disposing of a tyre which includes

separating the tyre into a number of different parts; and

compacting at least one of the parts to occupy a reduced volume.

According to a tenth aspect of the invention, there is provided a kit for disposing of a tyre, the kit comprising

a carrier carrying a coiling arrangement;

a lever arm for assisting in coiling a part of the tyre on the coiling arrangement; and

a cutting tool for cutting side wall portions of the tyre from a tread part of the tyre.

The kit may include a holder for holding the tyre as it is being cut by the cutting tool.

According to an eleventh aspect of the invention, there is provided a method of processing tyres, the method comprising

collecting, from a first location where tyre changing is normally effected, separated side walls and tread parts from each of a plurality of tyres, the side walls and the tread parts having been separately accumulated into a collection of side walls and a collection of tread parts; and

removing the collection of side walls and removing the collection of tread parts from the first location and transporting the collections to at least one further location remote from the first location.

The method may include, at the at least one further location, processing at least the collection of side walls. Further, the method may include, at one of the at least one further location and a different location, processing the collection of tread parts.

The method may include effecting the separation on a tyre changing machine modified to effect removal of the side walls from the tread part of the tyre.

The method may include storing the collection of side walls and the collections o tread parts in different storage facilities.

Further, the method may include separately removing the collection of side walls and the collection of tread parts.

According to a twelfth aspect of the invention, there is provided a method of processing tyres, the method comprising

collecting, from a first location where tyre changing is normally effected, separated side walls and tread parts from each of a plurality of tyres, the side walls and the tread parts having been separately accumulated into a collection of side walls and a collection of tread parts;

removing the collection of side walls and removing the collection of tread parts from the first location and transporting the collections to at least one further location remote from the first location;

at the at least one further location, processing at least the collection of side walls for a first desired usage; and

at one of the at least one further location and a different location, processing the collection of tread parts for a second desired usage.

The desired usage for both the collection of side walls and the collection of tread parts may be the recycling of the side walls and the tread parts to reclaim as much of the constituent materials of the side walls and tread parts as possible.

### BRIEF DESCRIPTION OF DRAWINGS

Embodiments of the invention are now described by way of example with reference to the accompanying diagrammatic drawings in which:—

FIG. 1 shows a schematic, side view of a conventional tyre changing machine;

FIG. 2 shows a schematic, side view of the tyre changing machine including a tyre cutting apparatus, in accordance with an embodiment of the invention, and an accessory for a tyre cutting apparatus, also in accordance with an embodiment of the invention;

FIG. 3 shows a three dimensional view of an embodiment of the tyre cutting apparatus;

FIG. 4 shows a plan view of the accessory;

FIG. 5 shows a bottom view of the accessory;

FIG. 6 shows, on an enlarged scale, a sectional side view of a part of the accessory;

FIG. 7 shows a schematic, sectional side view of the tyre cutting apparatus in use;

FIG. 8 shows a three dimensional view of another embodiment of the tyre cutting apparatus;

FIG. 9 shows a plan view of a carrier of a tyre disposing apparatus, in accordance with a further embodiment of the invention;

FIG. 10 shows a bottom view of the carrier of the tyre disposing apparatus;

FIG. 11 shows a side view of a spindle of the carrier of the tyre disposing apparatus;

FIG. 12 shows a three dimensional view of the tyre disposing apparatus, in use;

FIG. 13 shows a plan view of a tyre coiling tool, also in accordance with an embodiment of the invention, of the tyre disposing apparatus;

FIG. 14 shows an end view of the coiling tool;

FIG. 15 shows a side view of the lever member;

FIG. 16 shows a schematic, three dimensional view of an embodiment of a tyre disposing machine;

FIG. 17 shows a schematic, three dimensional view of another embodiment of a tyre disposing machine; and

FIG. 18 shows a schematic, three dimensional view of a tyre after being separated into a pair of side walls and a tread part.

### DETAILED DESCRIPTION OF EXEMPLARY EMBODIMENTS

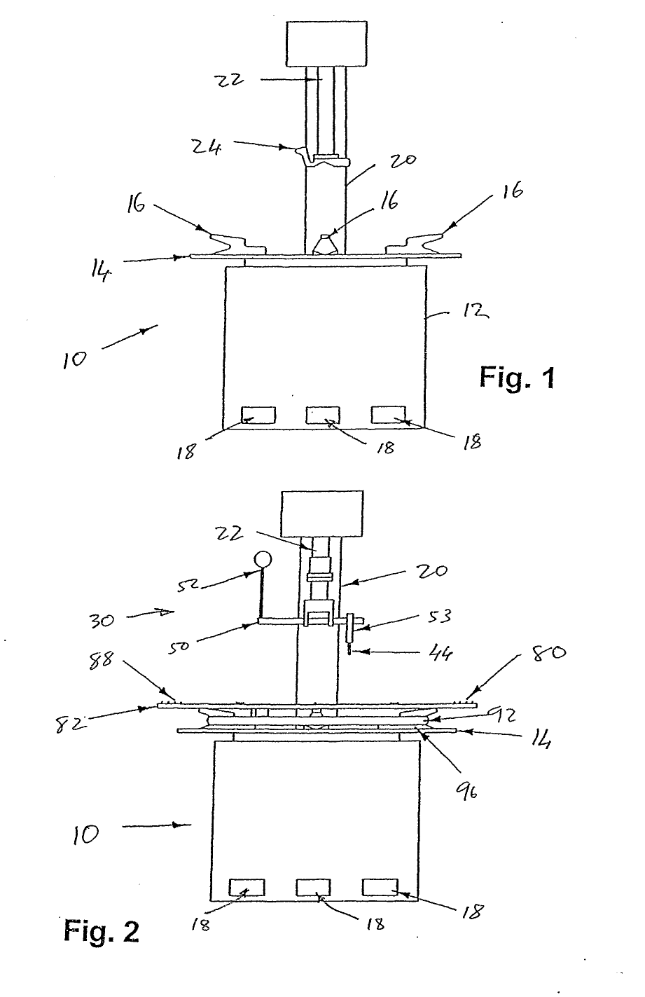

In FIG. 1 of the drawings, reference numeral 10 generally designates a conventional tyre changing machine. The tyre changing machine 10 comprises a housing 12 housing drive motors and control circuitry (not shown). A turntable 14 is rotatably mounted on top of the housing 12 and is rotatably driven by one of the drive motors.

The turntable 14 carries a clamping arrangement, comprising a plurality of orthogonally, radially displaceable clamps 16, for clamping a wheel assembly (not shown) to the turntable 14. In this regard, the tyre changing machine 10 is used for replacing a tyre on the wheel assembly and the clamps 16 are radially adjusted to grip the rim of the wheel assembly to enable the tyre to be removed from the wheel assembly and a new tyre fitted. To facilitate rotation of the turntable 14 and movement of the clamps 16, the tyre changing machine 10 includes a plurality of foot operated pedals 18. In some versions of tyre changing machines 10, certain of the operations may be controlled manually or by hand operated switches instead of the pedals 18.

A support arm 20 projects upwardly from the housing 12 and is arranged at the rear of the housing 12. The support arm 20 pivots towards and away from the housing 12. The support arm 20 supports a tool shaft 22. A removable tyre changing tool 24 is carried on a free end of the support arm 22 and is used to break a seal between the wheel rim and a bead of the tyre to facilitate removal of the tyre from the wheel rim. The tool 24 is also used to pull the bead over the wheel rim so that it lies on an outer side of the wheel rim.

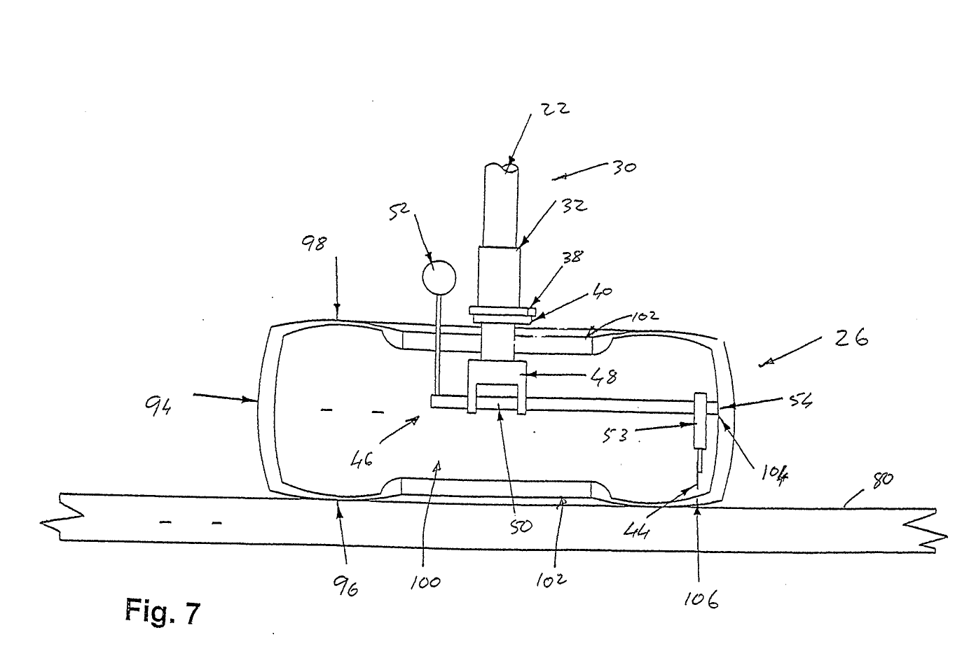

In a first embodiment, the tyre changing machine 10 is modified to facilitate disposal of used or waste tyres, one of which is shown at 26 in FIG. 7 of the drawings. By “disposal” is meant that the tyre is destroyed and, in destroying the tyre, the tyre 26 is cut into parts having different constituent materials. By “constituent materials” is meant the materials making up the parts of the tyre. For example, most tyres these days have a steel reinforced tread part whereas side walls of the tyre do not have the steel reinforcement. Thus, the constituent materials of the tread part include the steel reinforcing which is normally in the form of a band or mesh whereas the side walls are made up only of more flexible elastomeric compounds etc.

In the disposal of the tyre, a tyre cutting apparatus 30, in accordance with an embodiment of the invention, is mounted on the tyre changing machine 10. More particularly, as shown in FIG. 2 of the drawings, the tyre cutting apparatus 30 is mounted on the tool shaft 22 of the tyre changing machine 10 after removal of the tool 24 of the tyre changing machine 10.

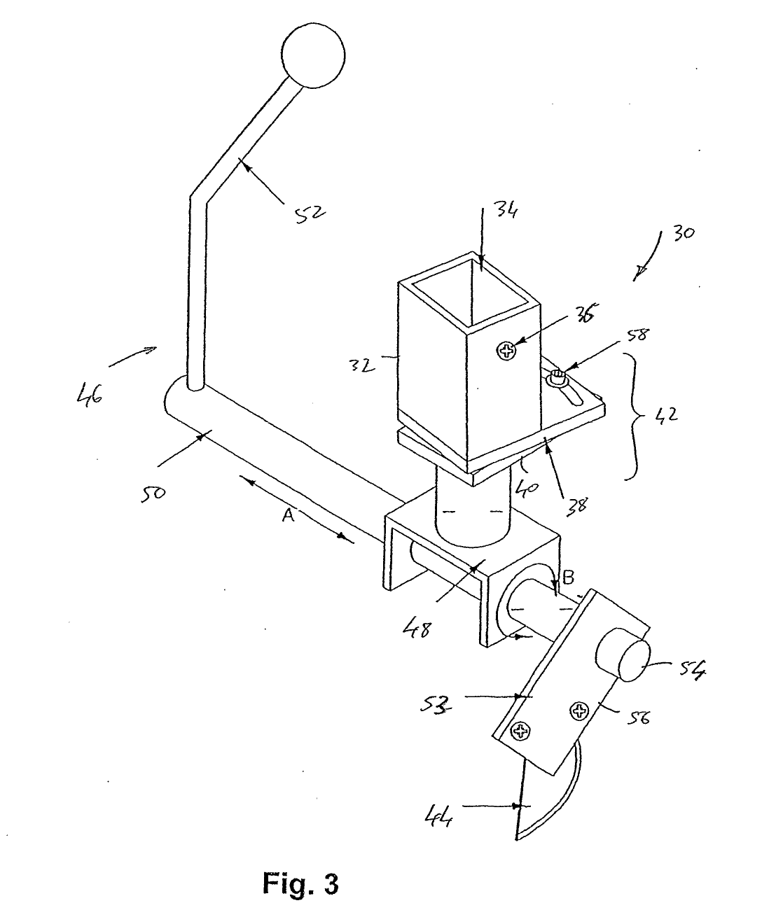

The apparatus 30 comprises a body member 32 defining a mounting formation 34 for mounting to the tool shaft 22. In the embodiment illustrated in FIG. 3 of the drawings, the mounting formation 34 is in the form of a socket defined by the body member 32. A locking screw 36 is arranged in a wall of the body member 32 for facilitating securing of the body member 32 to a free end of the tool shaft 22.

The body member 32 includes a first support plate 38 which is pivotally arranged relative to a second, underlying support plate 40 to provide an adjustment mechanism 42 for adjusting the angular position of a cutting blade 44 relative to the body member 32.

The apparatus 30 further includes a cutting assembly 46 incorporating the cutting blade 44. The cutting assembly 46 is supported by the body member 32 and, more particularly, a bracket 48 of the body member suspended from the plate 40. A shaft 50 of the cutting assembly 46 is axially and rotatably displaceably arranged relative to the bracket 48 as indicated by arrows A and B, respectively.

A control member in the form of a control handle 52 is arranged proximate a first end of the shaft 50 with a cutting unit 53, incorporating the cutting blade 44 arranged proximate, but inwardly of, a second end 54 of the shaft 50.

The cutting unit 53 includes a blade carrier 56 arranged inwardly of the second end 54 of the shaft 50 of the cutting assembly 46. The cutting blade 44 is carried by the blade carrier 56.

The adjustment mechanism 42 includes an adjustment screw 58 for adjusting the position of the plates 38 and 40 relative to each other and, in so doing, the angular displacement of the control handle 52 and the cutting unit 53 relative the tool shaft 22 of the tyre cutting machine 10.

While the cutting unit 53 has been shown with a single cutting blade 44 it will be appreciated that, in certain circumstances, it may be possible to have two, diametrically opposed cutting blades 44 to facilitate separation of both side walls simultaneously from a tread part of the tyre. Further, the cutting unit 53 could comprise a moveable, such as a rotatable, cutting blade. Still further the cutting unit 53 could be implemented as an energy-based cutting unit such as a laser cutter, an ultrasonic cutter, or the like

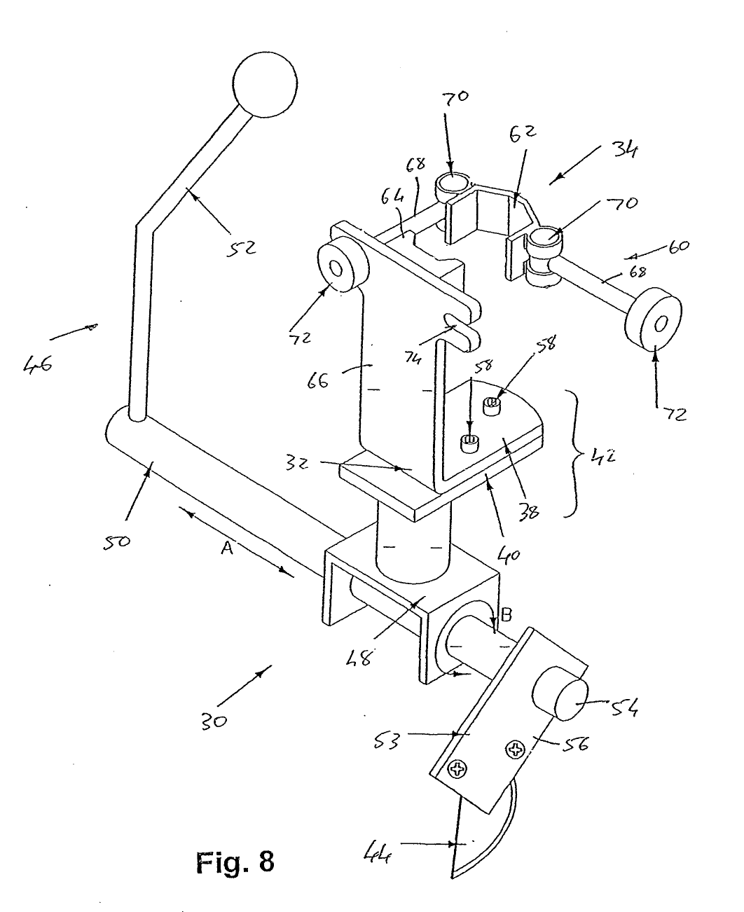

Referring to FIG. 8 of the drawings, another embodiment of the apparatus 30 is shown. With reference to FIG. 3 of the drawings, like reference numerals refer to like parts, unless otherwise specified.

In this embodiment, instead of the mounting formation 34 being in the form of a socket, the mounting formation 34 comprises a clamping arrangement 60. With this configuration, it may not be necessary to remove the tool 24 from the tool shaft 22. Rather, the apparatus 30 is mounted about the tyre changing tool 24.

The clamping arrangement 60 includes a clamping plate 62 and an opposed, back plate 64 carried by an arm 66 of the body member 32. In this embodiment, the body member 32 is a substantially L-shaped element having the arm 66 with the plate 38 extending at right angles from the arm 66.

The clamp 68 is held in spaced relationship relative to the back plate 64 via a pair of adjustable clamping screws 68. A first end 70 of each clamping screw 64 is hingedly attached to the clamping plate 62. A knurled thumbwheel 72 is carried on a free end of each screw 68. A shank of each screw 68 is received in a slot 74 defined in the arm 66 of the body member 32 and, by adjusting the thumbwheels 72, while the shanks of the screw 68 are in their respective slots 74, the clamping arrangement 60 is clamped about the tool shaft 22 to secure the apparatus 30 to the shaft 22.

The apparatus 30 is used in conjunction with a support member or holder 80, also in accordance with an embodiment of the invention. The holder 80 is a substantially circular planar plate 82 having a restraining arrangement 84 on an upper surface 86 of the plate 82.

The restraining arrangement 84 comprises a plurality of radially spaced, angled spikes 88 arranged in circumferentially spaced groups. One of the spikes 88 is shown in greater detail in FIG. 6 of the drawings. It will be noted that the spike 88 projects at an angle relative to the plate 82. The spike 88 is spot welded, as illustrated at 90, to the plate 82.

While the restraining arrangement has been described with reference to its being a plurality of spikes 88, it will be appreciated that any suitable restraining arrangement can be used relative to the plate 80 to inhibit rotation of the tyre 26 on the plate 82. For example, the restraining arrangement could be implemented as clamping jaws on the holder 80, a circumferential holding bracket on the holder 80, or the like.

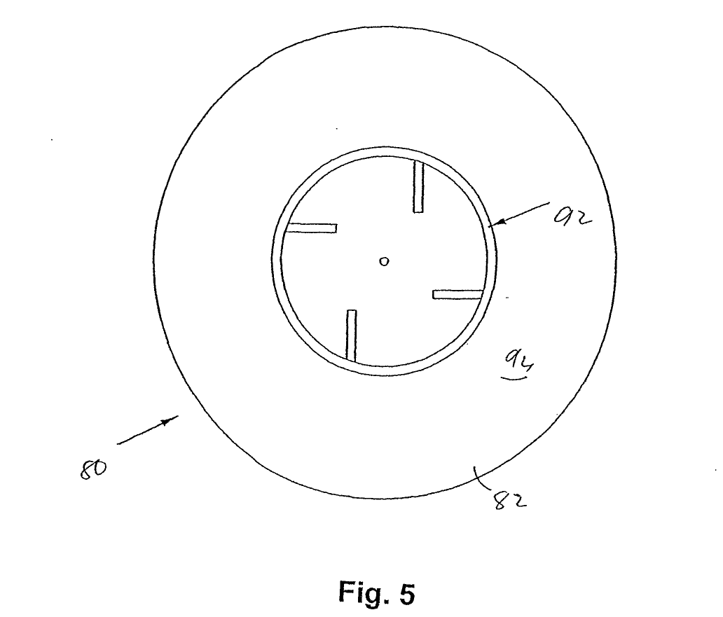

A mounting arrangement 92 (FIG. 5) is arranged on an under surface 94 of the plate 82. The mounting arrangement 92 cooperates with the clamps 16 of the tyre changing machine 10 for securing the holder 18 on the turntable 14 of the tyre changing machine 10 as illustrated schematically at 96 in FIG. 2 of the drawings.

In use, the apparatus 30 is mounted on the tool shaft 22 of the tyre changing machine 10. The holder 80 is mounted on the turntable 14 of the machine 10 via the mounting arrangement 92.

As shown more clearly in FIG. 7 of the drawings, the tyre 26 to be disposed of is mounted on the holder 80. The spikes 88 projecting from the surface 86 of the plate 82 restrain the tyre 26 against rotation relative to the holder 80.

The tyre 26 has a tread part 94, a first side wall portion 96 and an opposed, second side wall portion 98 which, together, define a tyre cavity 100 having opposed openings 102.

In use, once the tyre 26 has been position on the holder 80, the apparatus 30 is lowered via the tool shaft 22 of the machine 10 so that the cutting assembly 46 is received within the tyre cavity 100 via the upper opening 102. The cutting assembly 46 is manipulated using the control handle 52 so that the end 54 of the shaft 50 is brought lightly into abutment with an internal surface 104 of the tread part 94 of the tyre 26. Once the end 54 of the shaft 50 is so positioned, it forms a datum point so that an operator of the machine 10 knows that the cutting blade 44 is correctly positioned at the required point, illustrated by reference numeral 106 in FIG. 5 of the drawings, to effect removal of the lower side wall 96 from the tread part 94.

The apparatus 30 is further lowered so that the cutting blade 44 is brought into a cutting position relative to the side wall 96. The turntable 14 of the machine 10 is operated via the appropriate foot pedal 18 and, rotation of the turntable 14 relative to the cutting assembly 46 facilitates cutting of the side wall 96 and separation of the side wall 96 from the tread part 94 of the tyre 26.

Once the lower side wall 96 has been separated from the tread part 94, the remainder of the tyre carcass of the tyre 26 is flipped over so that the second side wall 98 now rests on the holder 80 and is restrained against rotation via the restraining arrangement 88.

The apparatus 30 is again lowered so that the cutting assembly 46 can be correctly positioned, as described above to position the blade 44 at the desired cutting location 106. The cutting blade 44 is then brought into cutting position relative to an internal surface of the side wall 98. The turntable 14 is again rotated with the cutting blade 44 in its cutting position to effect separation of the second side wall 98 from the tread part 94.

The side wall parts 96 and 98 of the tyre 26 are then stacked, together with previously separated side walls parts of other tyres on a suitable stacker (not shown).

The holder 80 is removed from the turntable 14 and, optionally, the apparatus 30 is removed from the tool shaft 22.

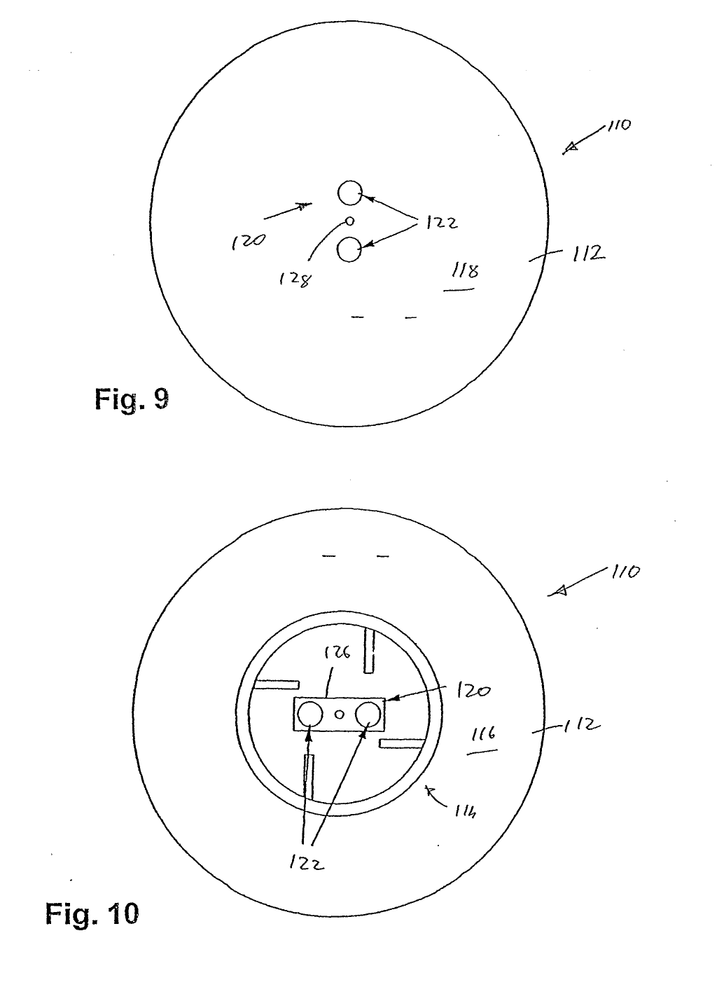

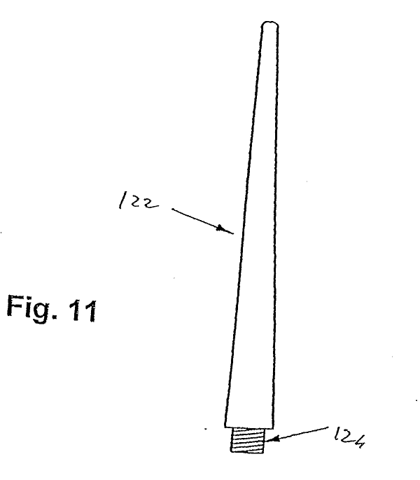

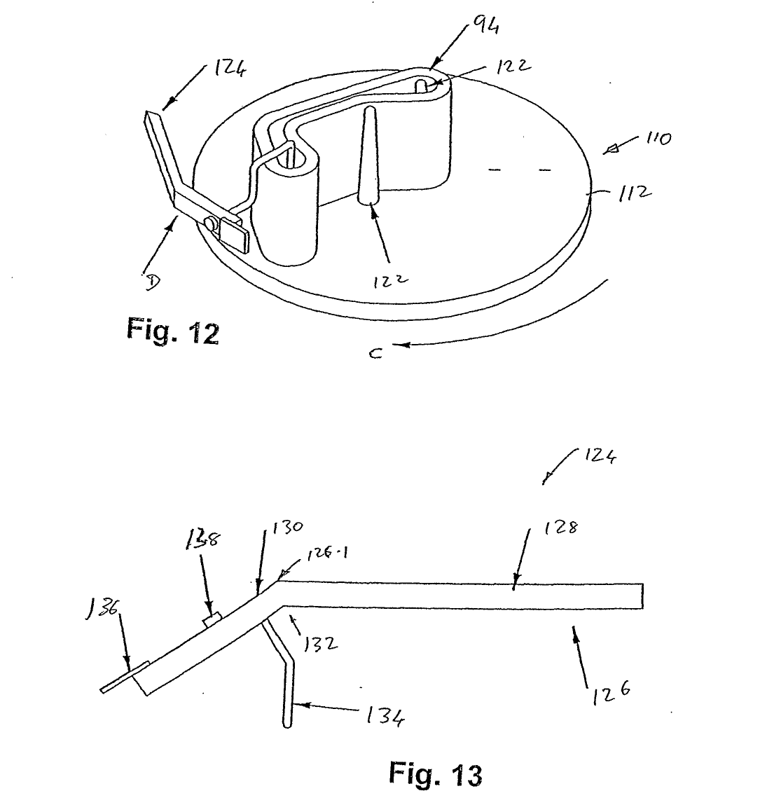

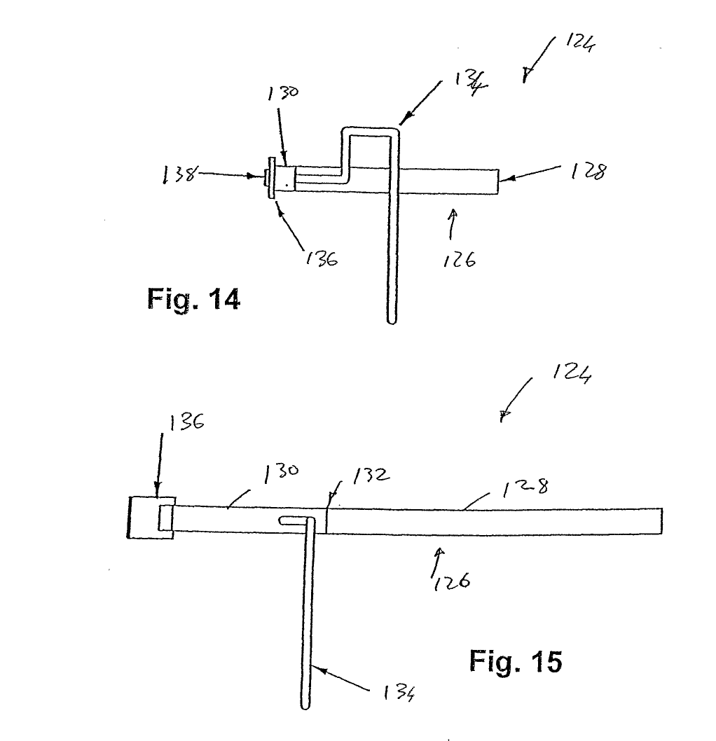

A tyre tread compacting apparatus 110 (FIGS. 9 and 10) is then mounted on the turntable 14 of the machine 10. The tyre tread compacting apparatus 110 comprises a carrier 112. The carrier 112 is a substantially circular, planar plate. The carrier 112 carries a mounting arrangement 114 on an operatively lower surface 116 of the carrier 112 for mounting on the turntable 14 of the machine 10, as will be described in greater detail below. An opposed, upper surface 118 of the carrier 112 carries a coiling mechanism 120. In the embodiment illustrated, the coiling mechanism 120 comprises a pair of spaced, vertically projecting spindles 122, one of which is shown in greater detail in FIG. 11 of the drawings. As illustrated, each spindle 122 has a threaded end 124 for insertion into a mounting plate 126 on the lower surface 116 of the carrier 112.

The spindles 122 are offset with respect to a rotational axis 128 of the carrier 112.

It will be appreciated that, instead of the two spindles 122 a greater number of spindles could be provided. Instead, a single, bifurcated spindle could constitute the coiling mechanism 120 of the apparatus 110.

Thus, in use, the tyre tread compacting apparatus 110 is mounted on the turntable 14 via the mounting arrangement 114 and is secured to the turntable 14 by means of the clamps 16. The tyre tread 94 of the tyre 26 to be compacted is mounted about a first of the spindles 122 with an outer surface of the tread part 94 bearing against the other spindle 122. The turntable 14 of the machine 10 is rotated in the direction of arrow C (FIG. 12) and a compacting or coiling force D is imparted to the tyre tread part 94 using a tyre coiling tool 124, also in accordance with an embodiment of the invention.

The tyre coiling tool 124 comprises a lever arm 126 which is cranked at 126.1 to form two limbs 128 and 130. The limbs 128 and 130 define a crook 132 having an obtuse angle. An engaging element in the form of a hook 134 is carried on the limb 130, the hook being offset with respect to the crook 132 and extending from that surface of the limb 130 forming the crook.

The hook 134 is, itself, doglegged to engage the tread part 94 of the tyre.

Thus, as the turntable 14 and, accordingly, the carrier 110 rotate, the tyre coiling tool 124 is used by engaging the tyre tread 94 with the hook 134 and exerting the coiling force D on the tread part 94. This coils the tread 94 into a compact form. Once the tread 94 has been coiled, a retaining element is mounted to the coiled tread part 94 to retain the tread part 94 in its compacted, coiled configuration. For example, the retaining element could be a self tapping screw screwed through the coiled tread part 94. However, it will be appreciated that other retaining elements could equally be used to retain the tread part 94 in its coiled configuration. For example, a strap or band could be used as the retaining element, another form of fastener such as a rivet or even an adhesive could be used as the retaining element.

To assist in levering the coils tread part 94 off the carrier 110, the tyre coiling tool 124 includes a secondary lever plate 136 projecting from a free end of the limb 130. A fulcrum 138 is arranged on an outer surface of the limb 130, i.e. opposite that surface from which the hook 134 extends. Thus, the lever plate 136 is placed under the coiled tread part 94 and the coiled tread part 94 is levered off the carrier 110 by pivoting the lever plate 136 upwardly about the fulcrum 138.

While the operation of the tyre changing machine 10, after removal of the side walls 96, 98 of the tyre 26, has been described with reference to compacting the tread part 94 by coiling it, it will be appreciated that the tread part could be compacted in other ways, for example, by first cutting the tread part 94 before coiling it, by cutting the tread part 94 into segments which are secured together, further comminuting of the tread part 94 such as, for example, by pelletising it before or after removing the steel bands, or the like.

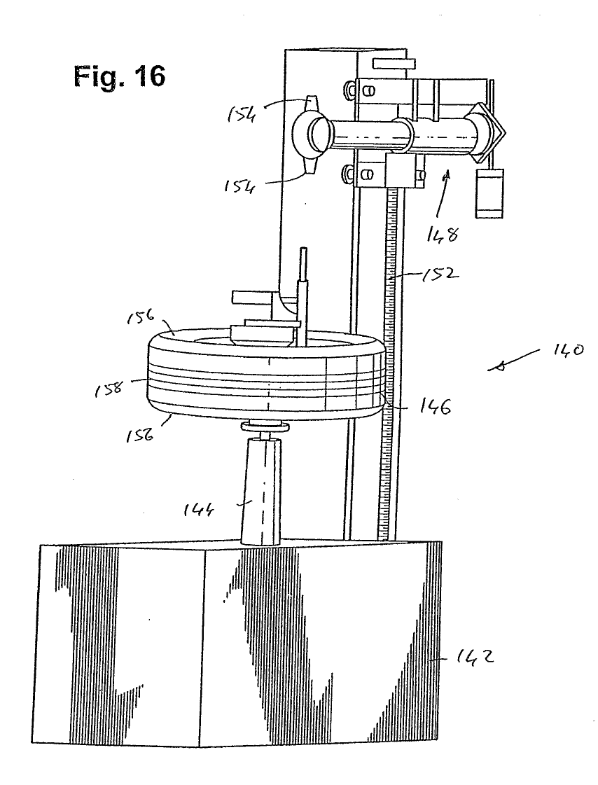

Further, while the embodiments have been described with reference to modifying and operating an existing tyre changing machine, a bespoke tyre disposing machine could, instead, be used. With reference to FIG. 16, a tyre disposing machine 140 is illustrated. The machine 140 has a housing 142 in which control equipment and drive motors (not shown) are housed. A pedestal 144 stands proud of the housing 142 and supports a tyre 146 in a horizontal orientation to be rotatable about a vertical axis. The tyre 146 is supported on a support structure (not shown) and is restrained against rotation relative to the support structure.

Tyre cutting apparatus 148, in accordance with an embodiment of the invention, is mounted on a support arm 150 of the machine 140. The tyre cutting apparatus 148 is vertically displaceable relative to the tyre 146 under the action of a drive system comprising a worm gear 152. The tyre cutting apparatus 146 comprises a pair of opposed cutting blades 154. The cutting blades 154 cut side walls 156 from a tread part 158 of the tyre 146.

In use, the cutting apparatus 148 is lowered into contact with an upper side wall 156 of the tyre 146. The tyre 146 is rotated while the cutting blade 154 separates the upper side wall 156 from the tread part 158. The cutting apparatus 148 is then lowered below the tyre 146 and is raised so that the upper cutting blade 154 cuts the lower side wall 156 and separates it from the tread part 158. The tread part 158 is retained by a retaining mechanism 160. The tread part 158 can then be compacted using a coiling apparatus, as described above with reference to FIGS. 9 to 11 of the drawings. Instead, some other form of compacting the tread part 158 could be effected by the machine 140. The tyre apparatus could either be mounted on the support structure permanently or, after cutting of the side walls 156 from the tyre 146 could be mounted on the support structure of the machine 140.

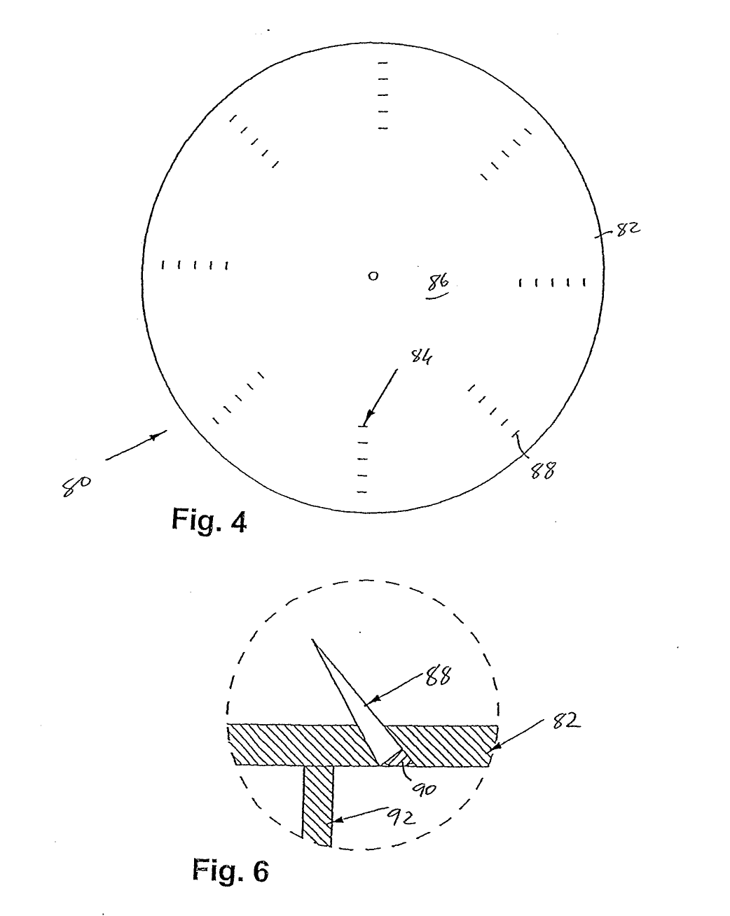

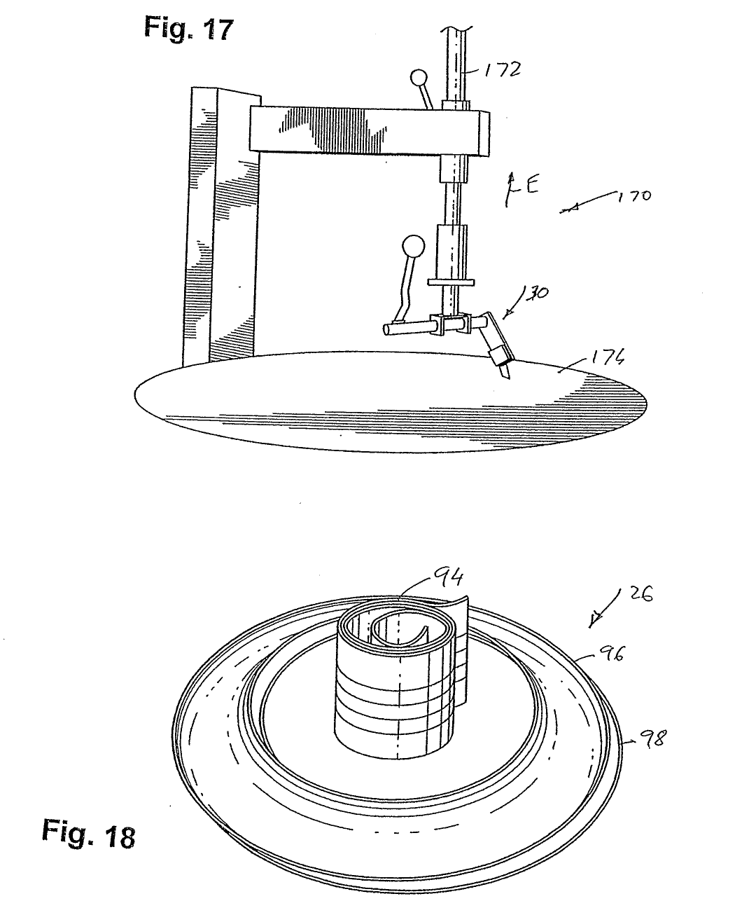

FIG. 17 shows a further embodiment of a tyre disposing machine 170 which includes a tyre cutting apparatus 30 substantially in the form as described with reference to FIGS. 2-7 above. The tyre cutting apparatus 30 is mounted on a retractable arm 172 so that, after cutting of the tyre, as described above, the tyre cutting apparatus 30 can be retracted upwardly, in a direction of arrow E to an inoperative position to facilitate coiling of the tread portion of the tyre using an apparatus 110, as described above with reference to FIGS. 9 and 10 of the drawings, mounted on a turntable 174 of the machine 170.

FIG. 18 shows a processed tyre 26 in which side wall portions 96 and 98 have been separated from a compacted tread portion 94. It is to be noted that, in this embodiment, the tread portion has been cut before being compacted by coiling. Further, it is to be noted that the separate parts occupy a substantially reduced volume in comparison with an intact tyre.

Once a plurality of the tyres 26 have been processed as described above, they are disposed of. While they can be disposed of to landfill and would occupy far less space, another, and preferred, option is that the processed tyre parts, being side walls 96 and 98 and tread parts 94 are collected by a waste management company and are transported for processing to at least one further location remote from the location at which the tyre changing machine 10 and/or the tyre disposing machines 140, 170 are located.

At the further location, the separated side walls 96 and 98 are treated in a first manner due to the difference in constituent materials of the side walls 96 and 98 from the constituent materials of the tread part 94. The side walls 96 and 98 can be processed in one way at the further location with the tread part 94 either being processed also at that remote location or at a further, different location.

Processing the side walls 96 and 98 and the tread parts 94 could include extracting the steel components, plastics components, rubber, carbon and hydrocarbons from the parts using appropriate recycling technology. All of the products resulting from recycling can be used in the relevant industries. For example, crumb rubber produced may be used for rubber coatings, asphalt mixes, sound insulation etc. The carbon can be used in the production of carbon black and activated carbon and the hydrocarbons can be used in the fuel industry.

Hence, it is a particular advantage of the invention that apparatus is provided that can be used on an existing tyre changing machinery to process tyres so that the processed tyres occupy a far more compact volume in comparison with an unprocessed tyre. Further, it enhances the business of a tyre changing facility in that the tyre changing machine can be used for a further purpose rather than purely the changing of tyres which results in improved business flow, enhances the versatility of the tyre changing machine and provides a business and economic system considerably superior to prior techniques for handling waste tyres.

Also, the apparatus could be used on dedicated tyre disposing machines which can be operated in a tyre changing facility in tandem with the tyre changing machines thereby enhancing the throughput of processed tyres for recycling and improving business efficiencies.

In addition, separating the tyres into different parts facilitates recycling of the parts as the parts can be treated more efficiently taking into consideration the constituent materials of the parts.

Even if the processed tyres are not recycled, the fact that they are in a compact form means they take up less space in landfill thereby reducing the problems associated with landfill sites.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1: A tyre cutting apparatus which includes
a body member defining a mounting formation for mounting to a support structure; and
a cutting assembly supported by the body member, the cutting assembly comprising a control member and a cutting unit for cutting the tyre, the control member effecting positional variation of the cutting unit relative to the body member.

2: The apparatus of claim 1 in which the body member comprises a bracket which receives the cutting assembly.

3: The apparatus of claim 2 in which the bracket is adjustably arranged relative to the mounting formation of the body member.

4: The apparatus of claim 1 in which the cutting assembly comprises a shaft received by the bracket, the shaft being axially and rotatably displaceably arranged relative to the bracket.

5: The apparatus of claim 4 in which the control member is arranged proximate a first end of the shaft and the cutting unit is arranged proximate a second end of the shaft.

6: The apparatus of claim 5 in which the second end of the shaft provides a datum point for positioning the cutting unit in a desired position relative to the tyre to be cut.

7: The apparatus of claim 4 in which the cutting unit comprises a blade carrier and at least one blade carried by the carrier, the blade lying in a plane transverse to a longitudinal axis of the shaft.

8: The apparatus of claim 4 in which the control member comprises a control handle extending transversely to the shaft.

9: The apparatus of claim 1 which includes a holder for holding a tyre to be cut.

10: The apparatus of claim 9 in which the holder comprises a support member and a restraining arrangement arranged on the support member.

11: The apparatus of claim 10 in which the support member comprises a substantially planar structure for supporting the tyre in a substantially horizontal orientation.

12: The apparatus of claim 9 in which the holder and cutting unit are rotatable relative to each other to effect cutting and removal of at least one side wall of the tyre.

13: An accessory for a tyre cutting apparatus, the accessory comprising
a holder for supporting the tyre to be cut by the apparatus; and
a restraining arrangement arranged on the holder for restraining the tyre against rotation relative to the holder.

14: The accessory of claim 13 in which the holder comprises a substantially planar structure for supporting the tyre in a substantially horizontal orientation.

15: The accessory of claim 13 in which the holder and a cutting unit of the apparatus are rotatable relative to each other to effect cutting and removal of at least one side wall of the tyre.

16: A tyre disposing machine which includes a tyre cutting apparatus of claim 1.

17: The tyre disposing machine of claim 16 which further includes an accessory of claim 13.

18: A tyre changing machine which includes a tyre cutting apparatus of claim 1.

19: The tyre changing machine of claim 18 in which the body member is mounted on a tool arm of the machine.

20: The tyre changing machine of claim 19 in which the body member is removably mounted on the tool arm.

21: The tyre changing machine of claim 20 in which the body member defines a receiving socket in which an end of the tool arm is received.

22: The tyre changing machine of claim 20 in which the body member includes a clamping arrangement for clamping about the tool arm.

23: A tyre changing machine which includes the accessory of claim 13.

24-51. (canceled)
